(19) United States
(12) Patent Application Publication
(10) Pub. No.: US 2003/0209122 A1
(43) Pub. Date: Nov. 13, 2003

(54) Paper roll cutter

(76) Inventor: Derick T. Nguyen, Irving, TX (US)

Correspondence Address: LITTMAN LAW OFFICES, LTD., P.O. BOX 15035 CRYSTAL CITY STATION, ARLINGTON, VA, 22215, US

(21) Appl. No.: 10/141,925

(22) Filed: May 10, 2002

(51) Int. Cl. B26D 1/10; B26D 7/01; B26D 5/10

(52) U.S. Cl. 83/614; 83/635; 83/522.11; 83/649

(57) ABSTRACT

Apparatus which can be employed for light, everyday hand-cutting of existing rolled material such as gift wrapping paper. The apparatus includes a frame whereon the roll of material can be positioned for rotary movement. The frame may be of fixed length to accommodate standard roll lengths or the frame may be made to be expandable if desired. A slot is provided to allow the material to be pulled therethrough. A cutter blade is disposed on the frame and is adapted to slide along a path parallel with the slot to perform a clean, even cut on the material.

### BACKGROUND OF THE INVENTION

1. Field of the Invention

The present invention generally relates to cutting devices. More specifically, the present invention is drawn to a device for efficiently cutting paper from a roll, especially gift wrapping paper.

2. Description of the Related Art

In lieu of having presents (Christmas, birthday, graduation, etc.) expensively wrapped at the place of purchase, the gift giver often desires to personally wrap the gifts. However, the art of “perfect” gift wrapping is somewhat elusive. One reason for the difficulty is that the person attempting to wrap is unable to utilize scissors to make an even cut along the edge of the paper. Uneven cuts lead to less than an aesthetic wrapping. A light-weight, inexpensive, efficient device employed to make these cuts, which device would also permit easy substitution of a different roll of material, would surely be a welcome addition to the art.

There is a plethora of prior art inventions available to perform cuts on sheet material. For example, U.S. Pat. Nos. 2,823,969 (Traver et al.), 3,142,217 (Busse), 3,919,905 (Hoffman), 4,787,284 (Chen) and 6,105,481 (Schuler) show devices for cutting various forms of rolled sheet material. However, all of the instant devices require that a housing is provided to enclose the rolled material therein, thereby discouraging substitution of another roll of material.

U.S. Pat. No. 4,944,441 (Gana) is drawn to a dispenser for cutting pre-determined discrete segments of tape.

U.S. Pat. No. 5,894,978 (Welch et al.) discloses a cutter for cutting flexible material held on a roll. The cutter is complex in that it employs a plurality of slitting knives for cutting the material in strips.

U.S. Pat. Nos. 5,979,062 (Prosan), 5,850,960 (Cadwell), 1,915,736 (Herlbut) and 5,480,080 (Ferguson) show devices for cutting paper such as gift wrap paper. The instant devices utilize fixed cutting blades which require that the paper be pulled there-across. The pulling process is often erratic, causing uneven cuts.

None of the above inventions and patents, taken either singularly or in combination, is seen to disclose a paper cutter as will be subsequently described and claimed in the instant invention.

### SUMMARY OF THE INVENTION

The present invention, in its preferred form, is a device which can be employed for light everyday hand-cutting of existing rolled material such as gift-wrapping paper. The device includes a frame whereon the roll of material can be positioned for rotary movement. The frame may be of fixed length to accommodate standard roll lengths or the frame may be made to be expandable if desired. A slit is provided to allow the material to be pulled therethrough. A cutter blade is disposed on the frame and is adapted to slide along a path parallel with the slit to perform a clean, even cut on the material. Elements are provided to temporarily mount the frame on a table top or the like for stability. Although the invention is discussed in relation with gift wrapping paper, it should be noted that the invention can be utilized to cut any sheet material (food wrap, paper towels, fabric, etc.) capable of being hand-cut.

Accordingly, it is a principal object of the invention to provide a device, which device is adapted to sever a sheet of material from a supply roll.

It is another object of the invention to provide a device, which device is adapted to sever a sheet of material from a supply roll along a smooth, even and clean cutting line.

It is a further object of the invention to provide a device for severing a sheet of material from a supply roll, which device is efficient and easy to operate.

Still another object of the invention is to provide a device for severing a sheet of material from a supply roll, which device is portable.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a roll cutter according to the present invention.

FIG. 2 is an end view of a roll cutter according to the present invention.

FIG. 3 is a top view of a roll cutter according to the present invention.

FIGS. 4A and 4B are plan views of anchoring devices for a roll cutter according to the present invention.

FIG. 5 is an exploded, top view of a second embodiment of a roll cutter according to the present invention.

FIG. 6 is a partial view of a cutting blade assembly for a roll cutter according to the present invention.

FIG. 7 is a perspective view of a third embodiment of a roll cutter according to the present invention.

Similar reference characters denote corresponding features consistently throughout the attached drawings.

### DETAILED DESCRIPTION OF THE PREFERRED EMBODIMENTS

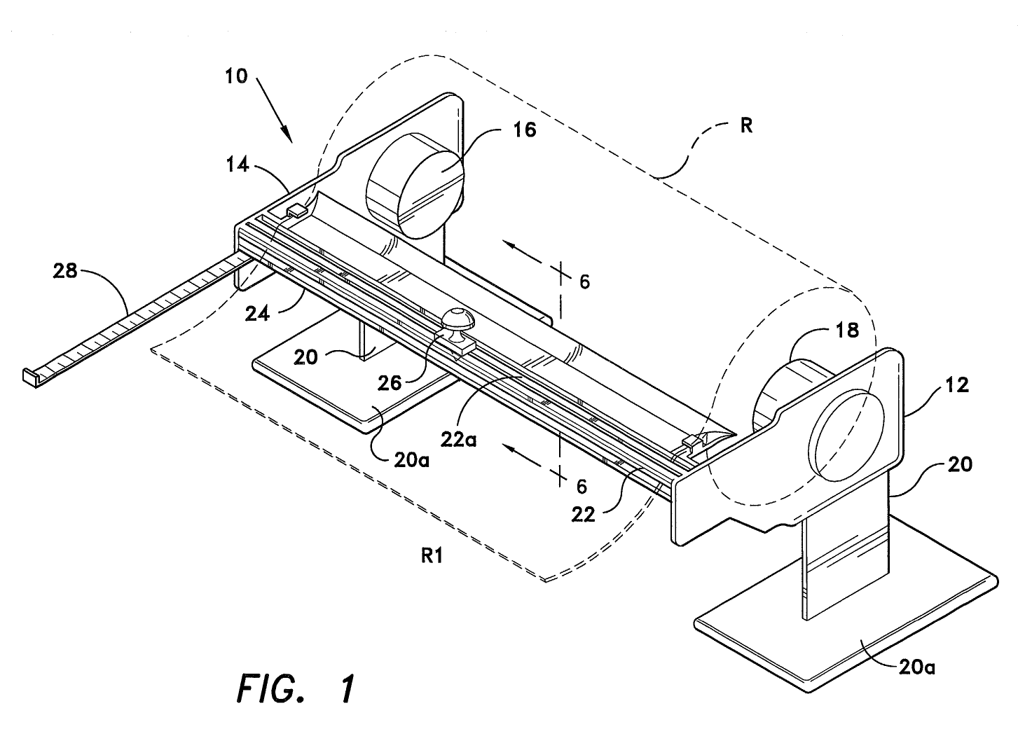

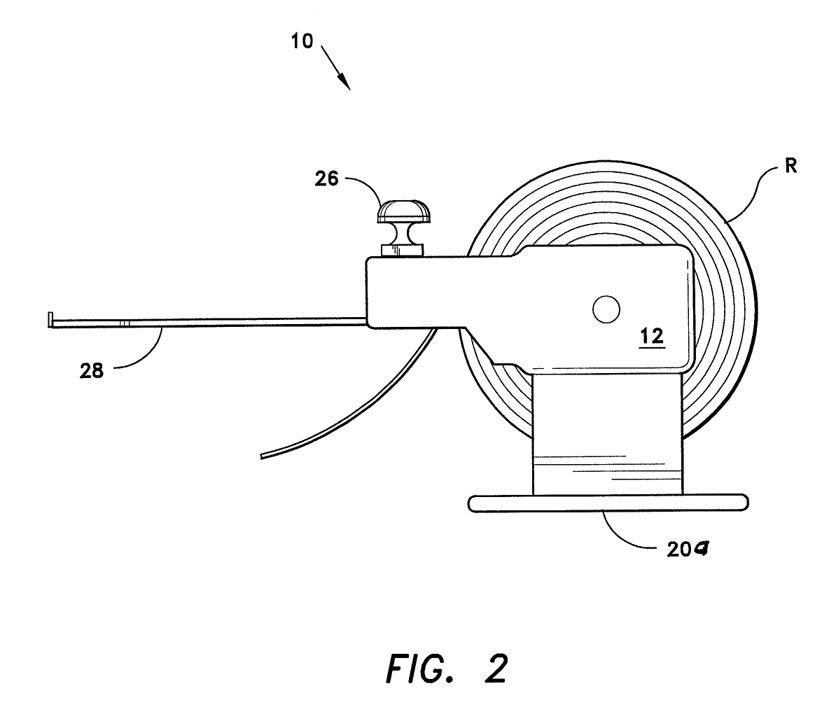

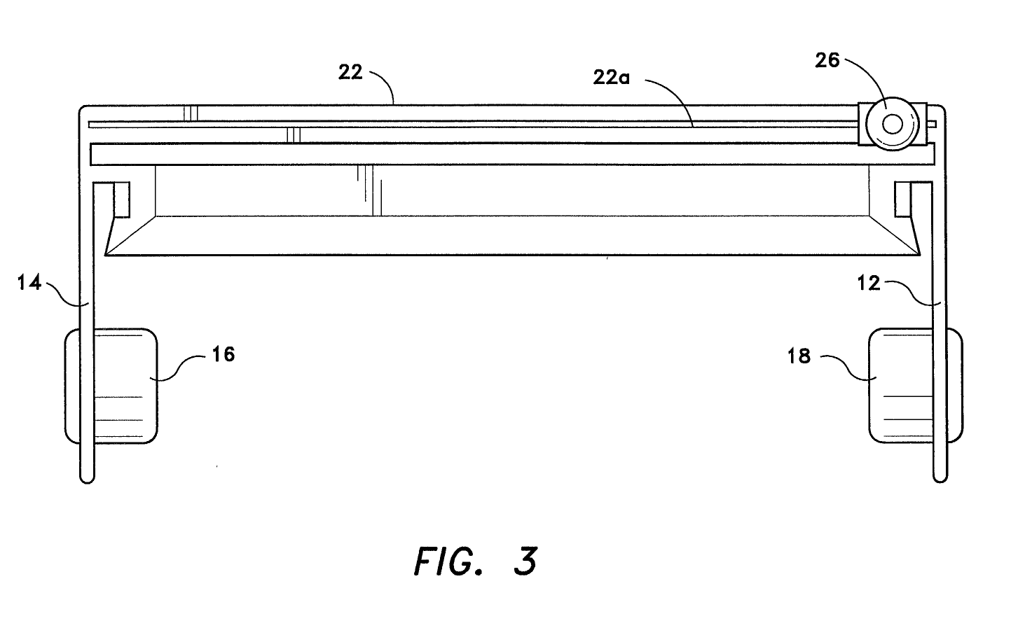

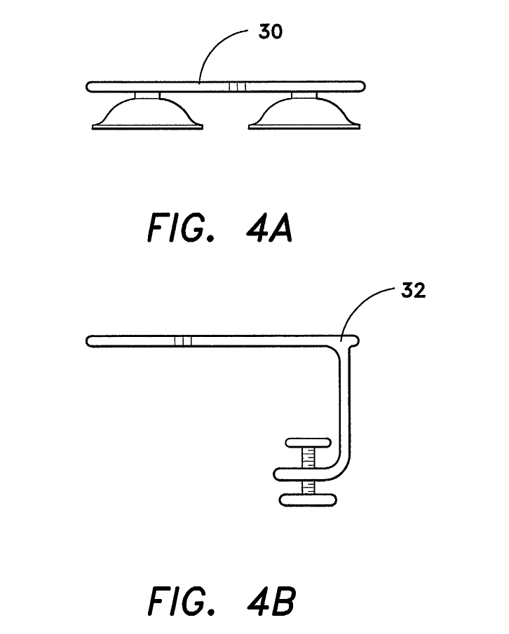

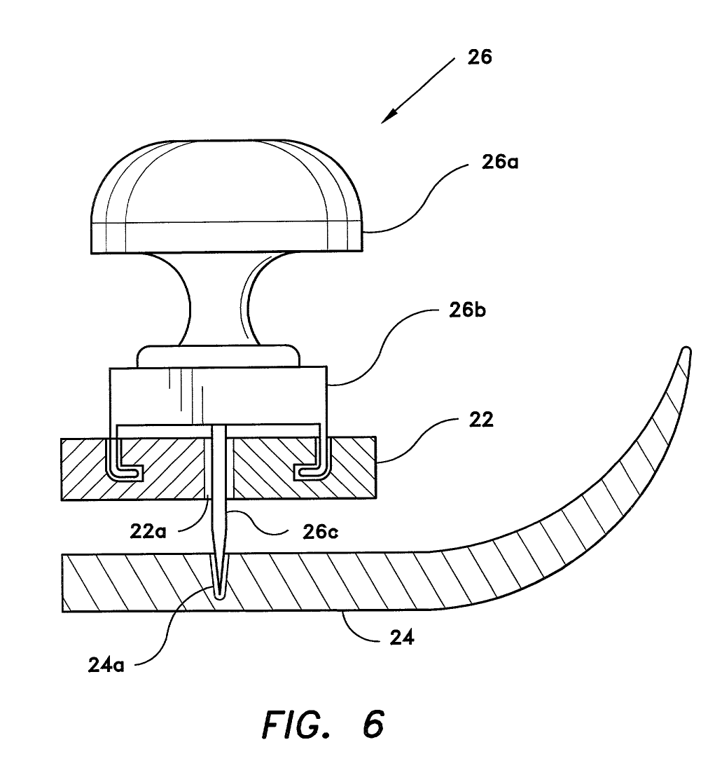

Attention is first directed to FIGS. 1-3 of the drawings wherein a first embodiment of the roll cutter of the present invention is generally designated at 10. Roll cutter 10 includes a frame having first and second sides 12 and 14. Respective inside faces of sides 12, 14 are provided with circular anchoring elements 16, 18. Elements 16, 18 are designed to receive the open ends of a roll of sheet material R. At their bottoms, sides 12, 14 incorporate base members 20. Base members 20 terminate in foot members 20a for supporting the cutter on a flat horizontal surface. Alternatively, members 20a may be omitted and the base members may be provided with slots and directly attached to a support surface. Upper and lower tracks 22, 24 extend between sides 12, 14 and are connected at respective inner faces to each side. Tracks 22 and 24 may be constructed in known telescopic fashion so that the working length of the cutter can be adjusted to accommodate different lengths of sheet material R. It is also contemplated that the sides of the device and the tracking unit may be collapsed or folded for size adjustability, packaging and storage ease. A narrow slot 22a is formed through upper track 22 and is substantially coextensive therewith. A cutting blade assembly 26 is mounted to slide along track 22 for purposes as will be explained below. A tape measure 28 is adapted to retractably extend from one end of the frame. As best seen in FIG. 6, cutting blade assembly 26 includes a pull knob 26a, a blade mount 26b and a cutting blade 26c. Cutting assembly 26 is replaceable if a more durable blade is needed for a heavier cut. A recess 24a is formed in lower track 24 to receive the cutting edge of blade 26c. Recess 24a is substantially coextensive with the length of lower track 24. An upwardly curved lip defines one side of lower track 24. As contemplated, all parts of cutter 10 may be fabricated from light-weight plastic or metallic material. Aside from conventional fasteners (nails, screws, bolts, etc.) which may be used for mounting the cutter for stability, FIGS. 4A and 4B illustrate devices in the form of suction cups 30 and clamps 32 (only one is shown) whereby the cutter can be quickly and easily removably mounted to a support surface.

In use, blade assembly 26 is positioned at one end of track 22 and a roll of sheet material R is mounted on cutter 10. An end R1 of the roll is threaded through the space between upper and lower tracks 22, 24. Tape measure 28 can be employed to ascertain the length of the sheet pulled through the tracks. When the desired length has been pulled, assembly 26 is pulled along the track whereby blade 26c will perform a quick, clean cut of the sheet.

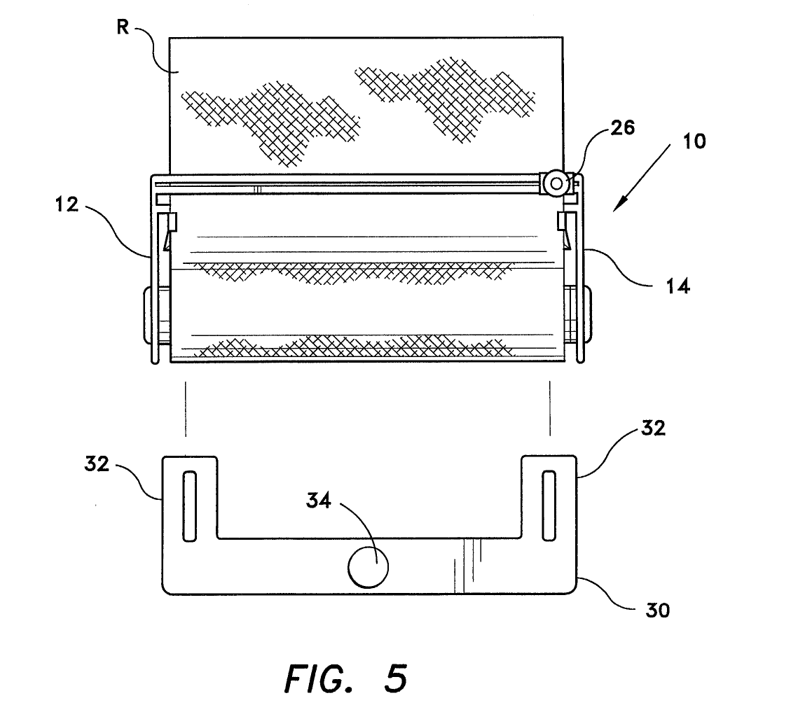

Attention is now directed to FIG. 5 which illustrates a variant of the instant invention which incorporates a hand-held mount substantially U-shaped 30. Mount 30 is fashioned so that ends 32 can be inserted between the base members of the cutter and retained therein. Mount 30 includes a hand knob 34 which is utilized to enhance stabilization when the device is hand-held. Mount 30 is also telescopically fashioned so as to adjust to different lengths of rolls.

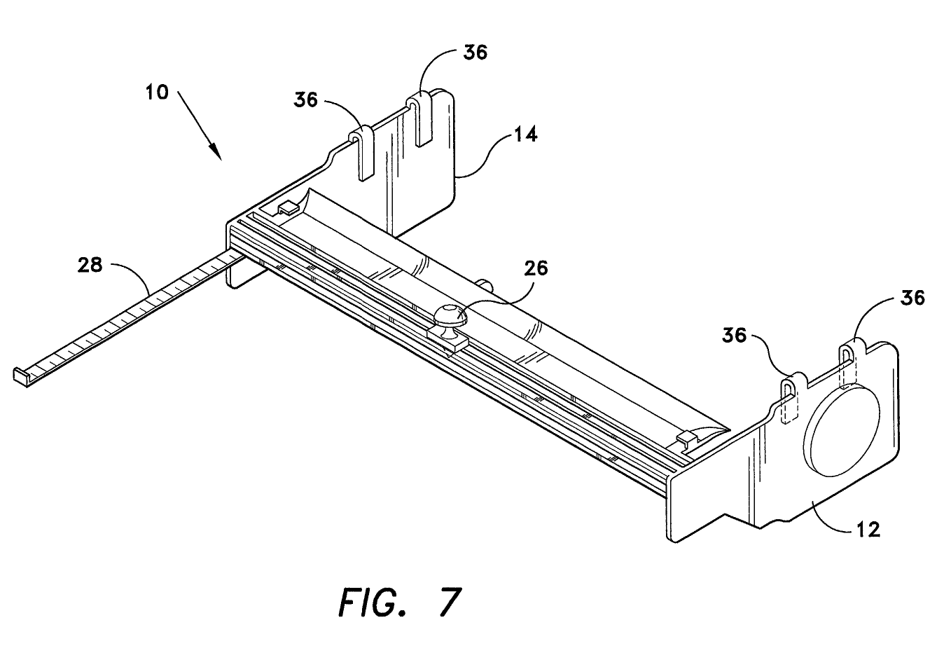

FIG. 7 is illustrative of an embodiment of the cutter which may be mounted directly to the frame of a conventional paper towel holder. The instant embodiment does not require anchoring elements since such elements are part of the paper towel holder. In lieu of anchoring elements the cutter is equipped with clips 36 at each side. Clips 36 are adapted to attach the cutter to the sides of the above mentioned paper towel holder. Although clips are illustrated, it should be noted that other conventional attachment elements (screws, clamps, etc.) may be utilized to attach the cutter to the paper towel holder.

It is to be understood that the present invention is not limited to the embodiments described above, but encompasses any and all embodiments within the scope of the following claims.

I claim:

1. An apparatus for cutting a roll of sheet material including:
a first side, said first side having an inner face;
a second side, said second side having an inner face, said second side being laterally spaced a distance from said first side;
a first anchoring element disposed on said inner face of said first side;
a second anchoring element disposed on said inner face of said second side, said first and said second anchoring elements adapted to support a roll of sheet material there between;
a track assembly, said track assembly having a first end and a second end, said track assembly spanning the distance between said first side and said second side; and
a cutting element, said cutting element mounted on said track assembly for sliding movement thereon.

2. An apparatus for cutting a roll of sheet material as recited in claim 1, wherein said first end of said track assembly is attached to said inner face of said first side and said second end of said track assembly is attached to said inner face of said second side.

3. An apparatus for cutting a roll of sheet material as recited in claim 2, wherein said track assembly includes an upper track member and a lower track member, said lower track member spaced vertically below said upper track member and wherein said lower track member is coextensive with said upper track member.

4. An apparatus for cutting a roll of sheet material as recited in claim 3, wherein said upper track member includes a narrow slot formed therethrough, said slot being substantially coextensive with said upper track member.

5. An apparatus for cutting a roll of sheet material as recited in claim 4, wherein said lower track member includes an upper surface and wherein an elongate groove is formed in said upper surface, said elongate groove being substantially coextensive with said lower track member.

6. An apparatus for cutting a roll of sheet material as recited in claim 5, wherein said cutting element includes a pull knob, said pull knob mounted for sliding movement on said upper track;
a cutting blade having a distal end, said cutting blade mounted in said pull knob and extending through said narrow slot, wherein said distal end of said cutting blade is disposed in said elongate groove formed in said upper surface of said lower track

7. An apparatus for cutting a roll of sheet material as recited in claim 6, wherein said lower track member includes an upwardly curved lip at one side thereof.

8. An apparatus for cutting a roll of sheet material as recited in claim 7, including an extendable tape measure, said tape measure attached at said first side.

9. An apparatus for cutting a roll of sheet material as recited in claim 8, including base members respectively disposed on said first side and said second side; and structures for attaching said base members to a support surface.

10. An apparatus for cutting a roll of sheet material as recited in claim 9, wherein said structures for attaching are suction cups.

11. An apparatus for cutting a roll of sheet material as recited in claim 9, wherein said structures for attaching are clamps.

12. An apparatus for cutting a roll of sheet material as recited in claim 9, including a u-shaped mount, said mount adapted to be inserted between said base members.

13. An apparatus for cutting a roll of sheet material as recited in claim 12, including a hand knob fixed to said U-shaped member.

14. An apparatus for cutting a roll of sheet material including:
a first side, said first side having an inner face;
a second side, said second side having an inner face, said second side being laterally spaced a distance from said first side;
at least one first clamp disposed on said inner face of said first side;
at least one second clamp disposed on said inner face of said second side, said first clamp and said second clamp adapted to support a conventional paper towel holder there between;
an expansible track assembly, said track assembly having a first end and a second end, said track assembly spanning the distance between said first side and said second side;
a cutting element, said cutting element mounted on said track assembly for sliding movement thereon; and
an extendable tape measure, said tape measure attached at said first side.

15. An apparatus for cutting a roll of sheet material as recited in claim 14, wherein said first end of said track assembly is attached to said inner face of said first side and said second end of said track assembly is attached to said inner face of said second side.

16. An apparatus for cutting a roll of sheet material as recited in claim 15, wherein said track assembly includes an upper track member and a lower track member, said lower track member spaced vertically below said upper track member and wherein said lower track member is coextensive with said upper track member.

17. An apparatus for cutting a roll of sheet material as recited in claim 16, wherein said upper track member includes a narrow slot formed therethrough, said slot being substantially coextensive with said upper track member.

18. An apparatus for cutting a roll of sheet material as recited in claim 17, wherein said lower track member includes an upper surface and wherein an elongate groove is formed in said upper surface, said elongate groove being substantially coextensive with said lower track member.

19. An apparatus for cutting a roll of sheet material as recited in claim 18, wherein said cutting element includes a pull knob, said pull knob mounted for sliding movement on said upper track;
a cutting blade having a distal end, said cutting blade mounted in said pull knob and extending through said narrow slot, wherein said distal end of said cutting blade is disposed in said elongate groove formed in said upper surface of said lower track member.

20. An apparatus for cutting a roll of sheet material as recited in claim 19, wherein said lower track member includes an upwardly curved lip at one side thereof.
